(19) United States
(12) Patent Application Publication
(10) Pub. No.: US 2026/0067996 A1
(43) Pub. Date: Mar. 5, 2026

(54) CERAMIC HEATER

(71) Applicant: NGK INSULATORS, LTD., Nagoya-City (JP)

(72) Inventors: Nobuyuki KONDO, Chita-Gun (JP); Yutaka UNNO, Handa-Shi (JP)

(73) Assignee: NGK INSULATORS, LTD., Nagoya-City (JP)

(21) Appl. No.: 19/383,868

(22) Filed: Nov. 10, 2025

Related U.S. Application Data
(63) Continuation of application No. PCT/JP2025/014874, filed on Apr. 16, 2025.

(30) Foreign Application Priority Data
Aug. 23, 2024 (JP) 2024-141947

(51) Int. Cl. H05B 3/14; H05B 3/00; H05B 3/06; H05B 3/28

(52) U.S. Cl. CPC H05B 3/143; H05B 3/0019; H05B 3/06; H05B 3/283; H05B 2203/005; H05B 2203/014; H05B 2203/016

(57) ABSTRACT

There is provided a ceramic heater including: a ceramic plate having a first surface and a second surface; a heater circuit embedded therein; spherical terminals connected thereto; heater terminal holes; and heater rods that are inserted in the heater terminal holes respectively, are electrically connected to the spherical terminals, and extend in a direction away from the first surface. The heater circuit includes: a heater coil part positioned parallel to the first surface; and a heater element wire part composed of a resistive heating element in an element wire form, so as to extend from the heater coil part and so that a tip end thereof reaches an inside of the spherical terminals. In a cross-sectional view, the heater element wire part is arranged at a same depth position as a lower end of the heater coil part or at a deeper depth position closer to the second surface.

### CROSS-REFERENCE TO RELATED APPLICATIONS

This application is a continuation application of PCT/JP2025/014874 filed Apr. 16, 2025, which claims priority to Japanese Patent Application No. 2024-141947 filed Aug. 23, 2024, the entire contents all of which are incorporated herein by reference.

### BACKGROUND OF THE INVENTION

### 1. Field of the Invention

The present disclosure relates to a ceramic heater.

### 2. Description of the Related Art

In a film formation device for semiconductor manufacturing processes, a ceramic heater is used as a supporting stage for uniformly controlling the temperature of a wafer. Widely used as such a ceramic heater is one including: a ceramic plate for having the wafer placed thereon; and a circular cylindrical ceramic shaft attached to the ceramic plate. Further, as a ceramic heater, a multi-zone ceramic heater having a plurality of heating zones is also known.

Patent Literature 1 (JP2022-48064A) discloses a holding device including: a plate-like member, an internal electrode (e.g., a heater electrode) arranged inside the plate-like member; a via that is arranged inside the plate-like member so as to extend substantially perpendicularly to a surface of the plate-like member and is also electrically connected to the internal electrode; a terminal member capable of energizing the internal electrode; and a connection member that is electrically conductive and that electrically connects the via and the terminal member together. The connection member has a via-side connection part to be connected to the via; and a terminal-side connection part to be connected to the terminal member. The via-side connection part and the terminal-side connection part are arranged in mutually-different positions in a direction substantially parallel to a surface of the plate-like member.

### CITATION LIST

### Patent Literature

Patent Literature 1: JP2022-48064A

### SUMMARY OF THE INVENTION

Ceramic heaters are required to have little temperature difference (i.e., temperature uniformity) within the plane on which a wafer is placed. In particular, because processes are getting finer and more highly integrated in recent years, ceramic heaters are required to have even higher temperature uniformity. From this viewpoint, it is desired to minimize the temperature difference between the location where a resistive heating element is provided and other locations. For this purpose, it is desirable to arrange the resistive heating element as a heater circuit throughout the entire region of the ceramic heater. Further, a ceramic plate in which a resistive heating element is embedded is provided with a heater terminal hole for electrically connecting a power feeding rod (a heater rod) to the resistive heating element. Although a smaller heater terminal hole is desirable from the viewpoint of enhancing the temperature uniformity, because the value of an electric current flowing through the resistive heating element tends to increase as a process temperature becomes higher, there is a limit to miniaturization of the heater terminal hole. Further, around the heater terminal hole, it is desired to arrange the resistive heating element in a limited space. However, when an attempt is made to arrange a larger part of the resistive heating element in the limited space, a problem arises where a heater coil, which is a resistive heating element in a coil form, is easily exposed in the heater terminal hole. To avoid this problem, if the heater coil is arranged to stay away from the heater terminal hole, then a cool spot locally having a low temperature may be caused instead by insufficient heat generation, at the time of use in a semiconductor manufacturing process. A local center-cool temperature distribution accompanied by such a cool spot may cause tensile thermal stress. Such tensile thermal stress may become a cause of cracks.

The present inventors recently discovered that, by adopting a heater circuit including a heater coil part composed of a resistive heating element in a coil form and a heater element wire part composed of a resistive heating element in an element wire form and arranging the heater element wire part at the same depth as the lower end of the heater coil part or at a deeper depth closer to the bottom surface of the plate, it is possible to prevent the occurrence of cracks during use, while preventing the heater coil part from being exposed in a heater terminal hole and a local center-cool phenomenon from occurring.

Thus, it is an object of the present invention to provide a ceramic heater capable of preventing the occurrence of cracks during use, while preventing the heater coil part from being exposed in a heater terminal hole and the local center-cool phenomenon from occurring.

The present disclosure provides the following aspects.

### [Aspect 1]

A ceramic heater comprising:
a ceramic plate having a first surface for having a wafer placed thereon and a second surface opposite the first surface;
a heater circuit embedded in the ceramic plate;
at least one pair of spherical terminals that are embedded in the ceramic plate and are connected to the heater circuit;
at least one pair of heater terminal holes formed in the second surface of the ceramic plate so as to reach the spherical terminals, respectively; and
at least one pair of heater rods that are for feeding electric power to the heater circuit, are inserted in the heater terminal holes respectively, are also electrically connected to the spherical terminals respectively, and extend in a direction away from the first surface,
wherein the heater circuit includes
   a heater coil part positioned parallel to the first surface and composed of a resistive heating element in a coil form, and
   a heater element wire part composed of a resistive heating element in an element wire form not wound in a coil form, so as to extend from the heater coil part and so that a tip end thereof reaches an inside of the spherical terminals, and
wherein, in a cross-sectional view of the ceramic plate, the heater element wire part is arranged at a same depth position as a lower end of the heater coil part or at a deeper depth position closer to the second surface.

### [Aspect 2]

The ceramic heater according to aspect 1, wherein, when a terminal centerline is defined as a line extending parallel to the first surface and passing through a center of a virtual circle specified by a cross-sectional arc of the spherical terminal in a cross-sectional view of the ceramic plate, the heater element wire part is arranged along the terminal centerline.

### [Aspect 3]

The ceramic heater according to aspect 1 or 2, wherein the ceramic plate contains aluminum nitride or aluminum oxide.

### [Aspect 4]

The ceramic heater according to any one of aspects 1 to 3, wherein the spherical terminals are each composed of a resistive heating element having a same type of composition as that of the resistive heating element in the coil form.

### [Aspect 5]

The ceramic heater according to any one of aspects 1 to 4 wherein the resistive heating element contains at least one selected from the group consisting of tungsten, molybdenum, a tungsten-molybdenum alloy, tungsten carbide, a tungsten carbide titanium nitride composite material, a tungsten carbide aluminum oxide composite material, and niobium.

### [Aspect 6]

The ceramic heater according to any one of aspects 1 to 5, wherein, in a planar perspective view of the ceramic plate from the second surface, the heater coil part is not present in regions defined by the heater terminal holes.

### [Aspect 7]

The ceramic heater according to any one of aspects 1 to 6, further comprising a circular cylindrical ceramic shaft attached to the second surface of the ceramic plate and including an internal space.

### [Aspect 8]

The ceramic heater according to any one of aspects 1 to 7, wherein the heater element wire part does not penetrate the spherical terminals so as to protrude to an outside thereof, and the heater element wire part therefore terminates inside the spherical terminals.

### [Aspect 9]

The ceramic heater according to any one of aspects 1 to 8, wherein, in a planar view of the ceramic plate, the ceramic plate includes an inside zone defined as a circular region within a prescribed distance from a center of the ceramic plate; and an outside zone defined as an annular region outside the inside zone,
wherein the heater circuit includes:
   an inside zone heater circuit embedded in the inside zone of the ceramic plate and including the heater coil part and the heater element wire part; and
   an outside zone heater circuit embedded in the outside zone of the ceramic plate and including the heater coil part and the heater element wire part, and
wherein the pair of spherical terminals are connected to the inside zone heater circuit and to the outside zone heater circuit, respectively, and the heater rods are connected to the pair of spherical terminals, respectively.

### [Aspect 10]

The ceramic heater according to aspect 9, wherein, in a cross-sectional view of the ceramic plate, the inside zone heater circuit and the outside zone heater circuit are arranged on mutually-different planes.

### [Aspect 11]

The ceramic heater according to any one of aspects 1 to 8, wherein, in a planar view of the ceramic plate, the ceramic plate includes an inside zone defined as a circular region within a prescribed distance from a center of the ceramic plate; and an outside zone defined as an annular region outside the inside zone,
wherein the heater circuit includes:
   an inside zone heater circuit embedded in the inside zone of the ceramic plate and including the heater coil part and the heater element wire part;
   an outside zone heater circuit embedded in the outside zone of the ceramic plate and including the heater coil part and the heater element wire part; and
   a pair of jumpers that are embedded in the inside zone of the ceramic plate so as not to be in contact with the inside zone heater circuit and are composed of resistive heating elements in an element wire form extending from the heater element wire part of the outside zone heater circuit, and
wherein the pair of spherical terminals are connected to the inside zone heater circuit and to the jumpers, respectively, and the heater rods are connected to the pair of spherical terminals, respectively, with the proviso that the jumpers do not need to be arranged at the same depth position as the lower end of the heater coil part of the outside zone heater circuit or at a deeper depth position closer to the second surface.

### [Aspect 12]

The ceramic heater according to aspect 11, wherein, in a cross-sectional view of the ceramic plate, the inside zone heater circuit and the outside zone heater circuit are arranged on a mutually same plane.

### [Aspect 13]

The ceramic heater according to aspect 11, wherein, in a cross-sectional view of the ceramic plate, the inside zone heater circuit and the outside zone heater circuit are arranged on mutually-different planes.

### BRIEF DESCRIPTION OF THE DRAWINGS

FIG. 1 is a perspective cross-sectional view schematically showing an example of a ceramic heater according to the present invention and corresponds to Example 1.

FIG. 2 is a perspective top view schematically showing the ceramic heater shown in FIG. 1 and corresponds to Examples 1 and 2.

FIG. 3 is a schematic cross-sectional view conceptually showing an internal structure of a ceramic plate in the ceramic heater shown in FIG. 1 and corresponds to Examples 1 to 3.

FIG. 4 is a schematic cross-sectional view showing an example of a positional relationship between a spherical terminal and a heater element wire part.

FIG. 5 is a schematic cross-sectional view showing another example of a positional relationship between the spherical terminal and the heater element wire part.

FIG. 6 is a schematic cross-sectional view showing yet another example of a positional relationship between the spherical terminal and the heater element wire part.

FIG. 7 is a perspective cross-sectional view schematically showing another example of the ceramic heater according to the present invention and corresponds to Example 2.

FIG. 8 is a perspective cross-sectional view schematically showing yet another example of the ceramic heater according to the present invention and corresponds to Example 3. For the sake of convenience in the descriptions, jumpers 14c are depicted in a position slightly lower than the actual position, in order to illustrate, in an easy-to-understand manner, the configurations of an inside zone heater circuit 14a and the jumpers 14c which are actually positioned at the same height.

FIG. 9 is a perspective top view schematically showing the ceramic heater shown in FIG. 8 and corresponds to Examples 3 and 4.

FIG. 10 is a plan view schematically showing arrangement of a heater circuit in a central region of the ceramic plate shown in in FIG. 8 and corresponds to Example 3.

FIG. 11 is a schematic cross-sectional view conceptually showing an internal structure of the ceramic plate in the ceramic heater shown in FIG. 8 and corresponds to Example 3.

FIG. 12 is a perspective cross-sectional view schematically showing another example of the ceramic heater according to the present invention and corresponds to Example 4.

FIG. 13 is a schematic cross-sectional view conceptually showing an internal structure of a ceramic plate in the ceramic heater shown in FIG. 12 and corresponds to Example 4.

FIG. 14 is a schematic cross-sectional view conceptually showing an internal structure of a ceramic plate in an example of a ceramic heater that is not of the present invention and corresponds to Example 5 (a comparison example).

FIG. 15 is a schematic cross-sectional view conceptually showing an internal structure of a ceramic plate in another example of a ceramic heater that is not of the present invention and corresponds to Example 6 (another comparison example).

### DETAILED DESCRIPTION OF THE INVENTION

A ceramic heater according to the present invention is a stage made of ceramics for supporting a wafer in a semiconductor manufacturing device. Typically, the ceramic heater according to the present invention may be a ceramic heater for a semiconductor film formation device. Typical examples of film formation devices include Chemical Vapor Deposition (CVD) devices (e.g., thermal CVD devices, plasma CVD devices, photo-assisted CVD devices, and MOCVD devices) and Physical Vapor Deposition (PVD) devices.

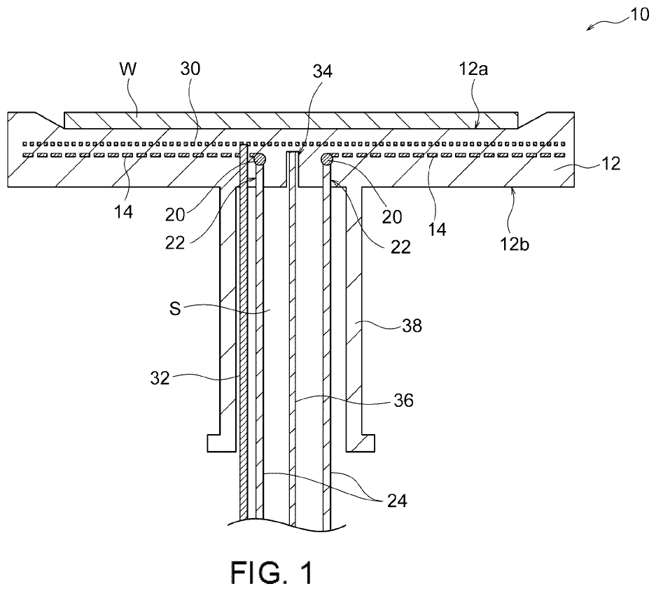

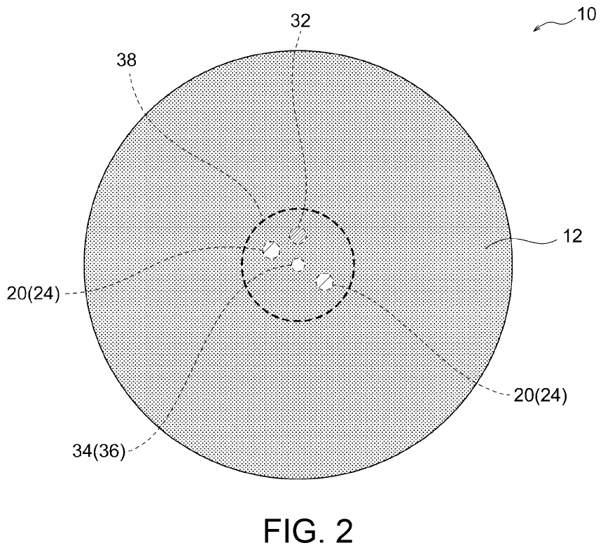

FIGS. 1 to 3 illustrate one aspect of the ceramic heater. A ceramic heater 10 shown in FIGS. 1 and 2 includes: a ceramic plate 12, a heater circuit 14, at least one pair of spherical terminals 20, at least one pair of heater terminal holes 22, and at least one pair of heater rods 24. The ceramic plate 12 has a first surface 12a for having a wafer W placed thereon and a second surface 12b opposite the first surface 12a. The heater circuit 14 is embedded in the ceramic plate 12. The spherical terminals 20 are embedded in the ceramic plate 12 and are connected to the heater circuit 14. The heater terminal holes 22 are holes formed to extend from the second surface 12b of the ceramic plate 12 to reach the spherical terminals 20, respectively. The heater rods 24 are electrode terminals in a rod form for feeding electric power to the heater circuit 14. The heater rods 24 are inserted in the at least one pair of heater terminal holes 22 respectively, are also electrically connected to the at least one pair of spherical terminals 20 respectively, and extend in a direction away from the first surface 12a. The heater circuit 14 includes a heater coil part 16 and a heater element wire part 18. The heater coil part 16 is composed of a resistive heating element in a coil form and positioned parallel to the first surface 12a. The heater element wire part 18 is composed of a resistive heating element in an element wire form not wound in a coil form, so as to extend from the heater coil part 16, and so that tip ends of the heater element wire part 18 reach the insides of the spherical terminals 20. Further, in a cross-sectional view of the ceramic plate 12, the heater element wire part 18 is arranged at the same depth position as a lower end of the heater coil part 16 or at a deeper depth position closer to the second surface 12b. In this manner, by adopting the heater circuit 14 including the heater coil part 16 composed of the resistive heating element in the coil form and the heater element wire part 18 composed of the resistive heating element in the element wire form and arranging the heater element wire part 18 at the same depth position as the lower end of the heater coil part 16 or at the deeper depth position closer to the second surface 12b, it is possible to prevent the occurrence of cracks during use, while preventing the heater coil part 16 from being exposed in the heater terminal holes 22 and the local center-cool phenomenon from occurring.

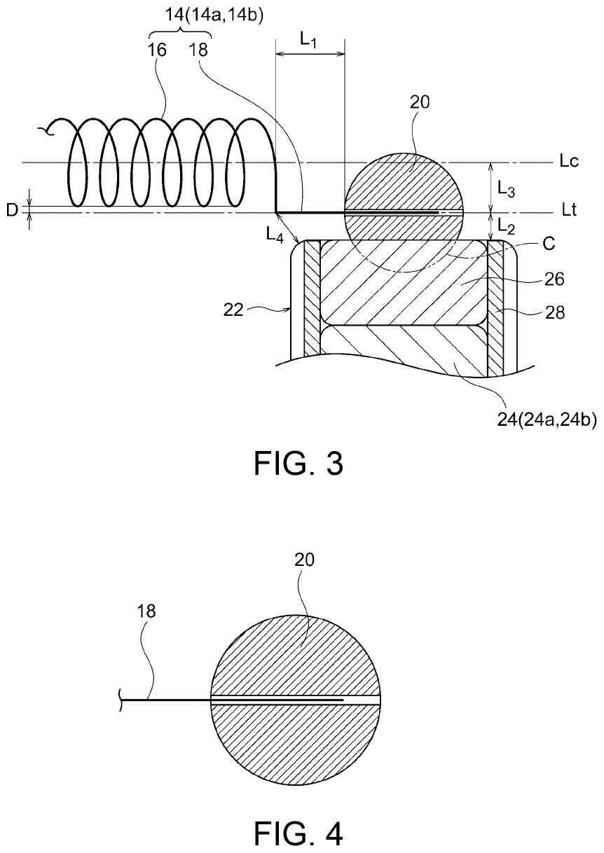

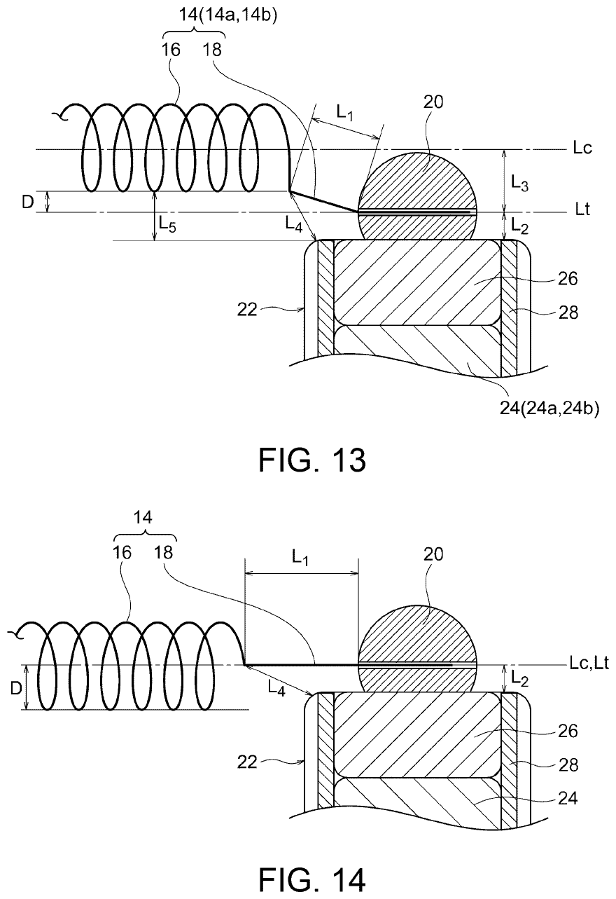

As described earlier, because processes are getting finer and more highly integrated in recent years, ceramic heaters are required to have even higher temperature uniformity. For this purpose, it is desirable to arrange a resistive heating element as a heater circuit throughout the entire region of a ceramic heater. Further, although a smaller heater terminal hole is desirable from the viewpoint of enhancing the temperature uniformity, because the value of an electric current flowing through the resistive heating element tends to increase as a process temperature becomes higher, there is a limit to miniaturization of the heater terminal hole. Further, around the heater terminal hole, it is desired to arrange the resistive heating element in a limited space. However, when an attempt is made to arrange a larger part of resistive heating element in the limited space, a problem arises where a heater coil, which is a resistive heating element in a coil form, is easily exposed in the heater terminal hole. In view of this, needless to say, ceramic heaters should be designed with a specification in which the heater coil is not intrinsically exposed in the heater terminal hole; however, the heater coil may inadvertently be exposed. In other words, a ceramic plate is produced by arranging a heater circuit and the like together with ceramic powder on a powder compact made of ceramic powder and further performing press-molding and firing thereon. Thus, during the series of processes, the heater circuit, in particular the heater coil, may shift from an expected position or may be deformed. As a result, when a heater terminal hole is formed in the fired ceramic plate, the heater coil may be exposed in the heater terminal hole. Further, if the heater coil is exposed in the heater terminal hole, an exposed portion of the material (typically molybdenum or tungsten) of which the heater coil is composed may rapidly be oxidized and dissipate, due to being exposed to a high temperature (e.g., 500° C.) at the time of use in a semiconductor manufacturing process, which may turn into a situation where a part of the heater circuit is lost (i.e., the heater circuit is disconnected). To avoid this problem, if the heater coil is arranged to stay away from the heater terminal hole, then a cool spot locally having a low temperature may be caused instead by insufficient heat generation, at the time of use in a semiconductor manufacturing process. For example, as shown in FIG. 14, to keep the heater coil part 16 and the heater terminal hole 22 (in particular, the hole bottom thereof) away from each other, because it is necessary to make the heater element wire part 18 long, coil density may relatively be lowered in that part, and as a result, a cool spot may be caused. A local center-cool temperature distribution accompanied by such a cool spot may cause tensile thermal stress. Such tensile thermal stress may become a cause of cracks. The present invention is able to successfully solve these problems. More specifically, in the present invention, as shown in FIGS. 3 and 13, by arranging the heater element wire part 18 at the same depth position as the lower end of the heater coil part 16 or at a deeper depth position closer to the second surface 12b, it is possible to keep the heater coil part 16 away from the heater terminal holes 22 (in particular, the hole bottoms thereof) in the direction toward the first surface 12a. As a result, even if deformation occurs at the time of manufacturing the ceramic plate 12, it is possible to reduce the risk of having the heater coil part 16 exposed in the heater terminal holes 22. Because it is possible to prevent the coil exposure in this manner, it is possible to enhance the coil density by positioning the heater coil part 16 closer to the spherical terminals 20 in a horizontal direction and to prevent the occurrence of a cool spot. In other words, it is possible to prevent, at the same time, the heater coil part 16 from being exposed in the heater terminal holes 22 and the center-cool phenomenon from occurring. Further, because the prevention of the center-cool phenomenon reduces tensile thermal stress, it is also possible to prevent cracks from being caused by such tensile thermal stress.

In view of providing a principal part (i.e., a ceramic base body) other than embedded members such as the heater circuit 14, the spherical terminals 20, and an RF electrode 30 with excellent thermal conductivity, high electric insulation, and a thermal expansion characteristic close to that of silicon, the ceramic plate 12 preferably contains aluminum nitride or aluminum oxide and more preferably contains aluminum nitride.

The ceramic plate 12 has a disc shape; however, the shape of the disc-shaped ceramic plate 12 does not necessarily need to be a perfect circle in a planar view and may be an imperfect circle of which a section is missing, like an orientation flat. The diameter of the ceramic plate 12 is 220 mm or larger and is typically in the range of 220 mm to 450 mm and, especially for a 300-mm silicon wafer, is typically in the range of 320 mm to 380 mm. Further, the thickness of the ceramic plate 12 is typically in the range of 10 mm to 25 mm.

The heater circuit 14 is embedded in the ceramic plate 12 so as to be positioned substantially parallel to the first surface 12a. In this situation, the expression “substantially parallel” is satisfied when the heater circuit 14 is positioned, as shown in FIG. 13, in such a manner that the heater coil part 16 being a principal section of the heater circuit 14 is positioned parallel to the first surface 12a and denotes that at least a part of the heater element wire part 18 may be parallel or may not be parallel to the first surface 12a (see, for example, the heater element wire part 18 positioned partially diagonally in FIG. 13). In addition, being “positioned parallel to the first surface 12a” does not necessarily mean being positioned completely parallel to the first surface 12a and may mean being positioned substantially parallel. More specifically, even when the distance from the first surface 12a to the heater coil part 16 varies within the range of +20% from an average value of distances from the first surface 12a to the heater coil part 16, it is considered that being “positioned parallel to the first surface 12a” is satisfied. In this situation, the “distance from the first surface 12a to the heater coil part 16” denotes the distance from the upper end of the heater coil part 16 on the first surface 12a side (the highest point closest to the first surface 12a on a substantially annular cross-section observed as the heater coil 16 is viewed on a cross-section in the coil center axis direction) to the first surface 12a. Typically, the heater circuit 14 may be realized by arranging a resistive heating element all over the entire region of the ceramic plate 12 in the manner of a single uninterrupted line. The form of the single uninterrupted line may be any of various publicly-known forms, such as a form in which advancing and folding back repeatedly alternate or a swirl. The ceramic plate 12 has formed therein the at least one pair of heater terminal holes 22 which extend from the second surface 12b so as to reach the spherical terminals 20, respectively. In the heater terminal holes 22, the heater rods 24 for feeding the electric power to the heater circuit 14 are inserted, respectively, and are electrically connected to the spherical terminals 20, respectively. The electric connection between the heater rods 24 and the spherical terminals 20 may be a direct connection or may be an indirect connection where other electrically conductive members such as buffering members 26, eyelets 28, or the like are interposed therebetween, as shown in FIG. 3, for example. The heater rods 24 extend in a direction away from the first surface 12a. For example, to the two ends of the heater circuit 14, the heater rods 24 inserted in the heater terminal holes 22 are connected via the spherical terminals 20 (and, optionally, the buffering members 26 and the eyelets 28). The heater rods 24 are electrically connected to a heater power source (not shown) (via an internal space S of a ceramic shaft 38, if provided). With a supply of electric power from the heater power source, the heater circuit 14 generates heat and heats the wafer W placed on the first surface 12a.

As shown in FIG. 3, the heater circuit 14 includes the heater coil part 16 and the heater element wire part 18. It is desirable to configure the heater coil part 16 and the heater element wire part 18 as a continuous integrally-formed resistive heating element; however, the heater coil part 16 and the heater element wire part 18 may be separate resistive heating elements that are connected to each other via a connection terminal. By using the connection terminal, it is possible to connect resistive heating elements having mutually-different wire diameters. It is desirable when the connection terminal is an electrically conductive member having two through holes which have mutually-different wire diameters and to which resistive heating elements having mutually-different wire diameters are connectable. With this configuration, it is possible to secure the electric connection of the heater coil part 16 and the heater element wire part 18, by inserting the heater coil part 16 and the heater element wire part 18 into the two through holes, respectively, and crimping and/or stabilizing the two. Although not particularly limited, the shape of the connection terminal may be spherical, for example. However, when the wire diameter of the heater coil part 16 is equal to the wire diameter of the heater element wire part 18, the connection terminal is not necessary.

The heater coil part 16 is composed of the resistive heating element in the coil form and is positioned parallel to the first surface 12a. The resistive heating element in the coil form has a structure in which a resistance heat generation wire is three-dimensionally wound and may be a heater coil that is generally used for a ceramic heater or the like. The winding diameter of the coil is preferably in the range of 2.5 mm to 5.0 mm, more preferably 2.5 mm to 4.0 mm, and even more preferably 3.0 mm to 3.5 mm. The wire diameter of the coil is preferably in the range of 0.3 mm to 0.7 mm, more preferably 0.4 mm to 0.6 mm, and even more preferably 0.4 mm to 0.5 mm.

The heater element wire part 18 is composed of the resistive heating element in the element wire form not wound in a coil form, so as to extend from the heater coil part 16, and so that the tip ends of the heater element wire part 18 reach the insides of the spherical terminals 20. In a cross-sectional view of the ceramic plate 12, the heater element wire part 18 is arranged at the same depth position as the lower end of the heater coil part 16 or at a deeper depth position closer to the second surface 12b. In the present disclosure, as for being at the “same” depth position, having a height difference within the range of +10% of the diameter of the spherical terminals 20 is considered as being at the “same” depth. Further, the diameter of each of the spherical terminals 20 is defined as the diameter of a virtual circle C specified by a cross-sectional arc of the spherical terminal 20. In other words, although the spherical terminals 20 may intrinsically be produced to have a spherical shape, when the ceramic plate 12 is processed to form the heater terminal holes 22, a part of the spherical terminals 20 may be shaved off or removed and may have an imperfect spherical shape with a flat part (hereinafter, “substantially spherical shape”) as shown in FIG. 3. The virtual circle C is a circle that is virtually set so as to fit the cross-sectional arc in the substantially spherical shape part. The diameter (the wire diameter) of the resistive heating element in the element wire form is preferably in the range of 0.3 mm to 0.7 mm, more preferably 0.4 mm to 0.6 mm, and even more preferably 0.4 mm to 0.5 mm.

The length L₁ (see FIGS. 3 and 13) of the part of the heater element wire part 18 that is not embedded in the spherical terminal 20 is not particularly limited, but may preferably be in the range of 2.0 mm to 3.5 mm, more preferably 2.0 mm to 3.0 mm, and even more preferably 2.0 mm to 2.5 mm. The shortest distance L₂ (see FIGS. 3 and 13) between the hole bottom of the terminal hole 22 and the heater element wire part 18 is not particularly limited, but may preferably be in the range of 1.0 mm to 1.5 mm, more preferably 1.0 mm to 1.3 mm, and even more preferably 1.0 mm to 1.2 mm.

In a preferable aspect of the present invention, in a cross-sectional view of the ceramic plate 12, the heater element wire part 18 may be positioned parallel to a coil centerline Lc of the heater coil part 16 as shown in FIG. 3. This configuration has an advantage of making it easier to form the heater circuit 14. It is particularly desirable to arrange the heater element wire part 18 along a terminal centerline Lt of the spherical terminal 20. In a cross-sectional view of the ceramic plate 12, the terminal centerline Lt is defined as a line extending parallel to the first surface 12a and passing through the center of the circle (i.e., the virtual circle C described above) specified by the cross-sectional arc of the spherical terminal 20.

In another preferred aspect of the present invention, in a cross-sectional view of the ceramic plate 12, the heater element wire part 18 may be provided diagonally or in the manner of an arc so as to be away from the coil centerline Lc of the heater coil part 16 as shown in FIG. 13. With this configuration, it is possible to keep the heater coil part 16 farther away from the heater terminal hole 22 (in particular, the hole bottom thereof) and to thus further reduce the risk of having the heater coil part 16 exposed in the heater terminal hole 22 due to deformation that may occur at the time of the manufacturing. Accordingly, it is possible to further enhance the coil density by positioning the heater coil part 16 closer to the spherical terminal 20 in the horizontal direction and to thus prevent the occurrence of a cool spot more effectively. Although the part of the heater element wire part 18 that is provided diagonally or in the manner of an arc is typically a part positioned outside the spherical terminal 20, a certain part positioned inside the spherical terminal 20 may also be provided diagonally or in the manner of an arc.

The distance L3 (see FIGS. 3 and 13) between the centerline Lc of the heater coil part 16 and the centerline Lt of the spherical terminal 20 is not particularly limited, but may preferably be in the range of 1.2 mm to 4.5 mm, more preferably 1.5 mm to 3.5 mm, and even more preferably 1.8 mm to 2.8 mm. The shortest distance L₄ (see FIGS. 3 and 13) between the hole bottom of the heater terminal hole 22 and the heater coil part 16 is not particularly limited, but may preferably be in the range of 1.5 mm to 4.0 mm, more preferably 1.5 mm to 3.5 mm, and even more preferably 1.5 mm to 3.0 mm. In this situation, the shortest distance L₄ is defined as the length of a straight line having the shortest distance that connects a vertex or an inflection point formed by the heater coil part 16 and the heater element wire part 18 to the hole bottom of the heater terminal hole 22, in a cross-sectional view of the ceramic plate 12.

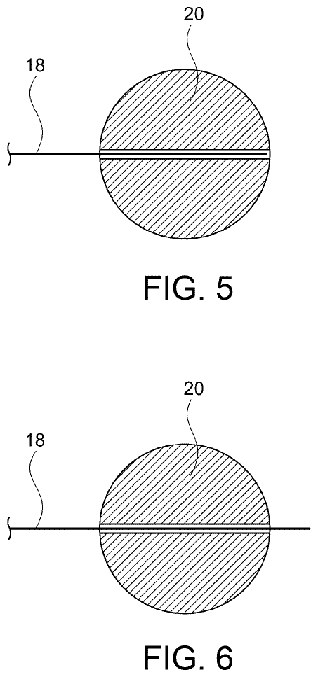

As shown in FIGS. 4 and 5, the heater element wire part 18 does not penetrate the spherical terminal 20 so as to protrude to the outside thereof. It is therefore desirable that the heater element wire part 18 terminates inside the spherical terminal 20. As shown in FIG. 6, if the heater element wire part 18 protruded from the spherical terminal 20, the protruding part of the heater element wire part 18 could be a starting point of a crack. Thus, by configuring the heater element wire part 18 to terminate inside the spherical terminals 20, it is possible to reduce such a risk.

The spherical terminals 20 are embedded in the ceramic plate 12 and are connected to the heater circuit 14. It is desirable that the spherical terminals 20 are each composed of a resistive heating element having the same type of composition as that of the resistive heating element in the coil form (i.e., the heater coil part 16). As described above, the spherical terminals 20 do not each necessarily need to have a perfect spherical shape and may have an imperfect spherical shape with a flat part, i.e., a substantially spherical shape, as shown in FIG. 3. The diameter of each of the spherical terminals 20 (i.e., the diameter of the virtual circle C) may preferably be in the range of 3.0 mm to 5.0 mm, more preferably 3.5 mm to 4.5 mm, and even more preferably 3.5 mm to 4.0 mm.

As described above, the heater element wire part 18 is arranged at the same depth position as the lower end of the heater coil part 16 or at a deeper depth position closer to the second surface 12b, while being preferably provided along the terminal centerline Lt of the spherical terminals 20. Accordingly, it is desirable to appropriately set the position, in the depth direction, of the terminal centerline Lt of each of the spherical terminals 20, in relation to the lower end of the heater coil part 16. For example, as shown in FIGS. 3 and 13, a depth position D of the centerline Lt of the spherical terminal 20 with respect to the lower end (the lower end closer to the second surface 12b) of the heater coil part 16 may preferably be in the range of 0 mm to +2.0 mm, more preferably 0 mm to +1.5 mm, and even more preferably +0.2 mm to +1.0 mm, where depth positions closer to the second surface 12b relative to the lower end of the heater coil part 16 are expressed with the positive sign (+).

In a planar perspective view of the ceramic plate 12 from the second surface 12b, it is desirable that the heater coil part 16 is not present in regions defined by the heater terminal holes 22. With this configuration, it is possible to effectively reduce the risk of having the heater coil part 16 exposed in the heater terminal holes 22 due to deformation at the time of the manufacturing or the like.

It is desirable that the resistive heating elements of which the heater circuit 14 (i.e., the heater coil part 16, the heater element wire part 18, and, if present, jumpers 14c) and the spherical terminals 20 are composed contains at least one selected from the group consisting of tungsten, molybdenum, a tungsten-molybdenum alloy, tungsten carbide, a tungsten carbide titanium nitride composite material, a tungsten carbide aluminum oxide composite material, and niobium.

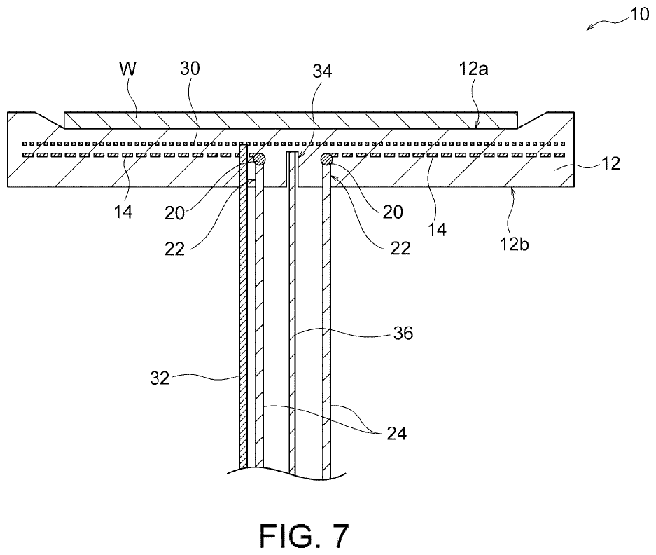

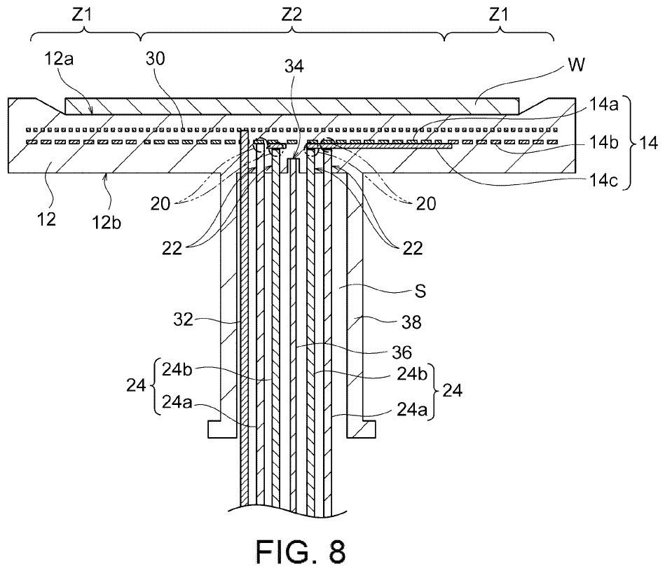

The ceramic heater 10 may be a one-zone heater or may be a multi-zone heater. In an example of a one-zone heater, the heater circuit 14 may be, as shown in FIGS. 1 and 7, one continuous heater circuit capable of heating the ceramic plate 12 as a whole. In contrast, in an example of a multi-zone heater (e.g., a two-zone heater), the ceramic plate 12 may, as shown in FIGS. 8, 9, and 12, include an inside zone Z1 and an outside zone Z2, in a planar view. The inside zone Z1 is defined as a circular region within a prescribed distance from the center of the ceramic plate 12. The outside zone Z2 is defined as an annular region outside the inside zone Z1. The outside zone Z2 may be divided into a plurality of outside subzones (e.g., into two to four sections). For example, the outside zone Z2 may be composed of the plurality of outside subzones sectioned into arc shapes (e.g., into two to four sections). Alternatively, the outside zone Z2 may concentrically have two or more annular regions that have mutually-different sizes and do not overlap with each other. In that situation, the outside zone Z2 has at least a first outside zone being in proximity to the inside zone Z1 and a second outside zone positioned outside the first outside zone. If necessary, a third or more outside zones may be present outside the second outside zone.

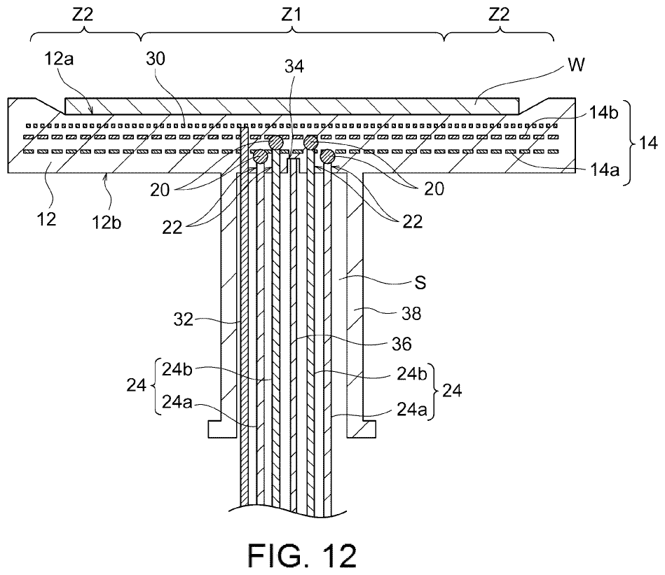

In an example of a multi-zone heater (e.g., a two-zone heater), the heater circuit 14 may, as shown in FIGS. 8 to 12, include an inside zone heater circuit 14a, an outside zone heater circuit 14b, and optionally the pair of jumpers 14c. In other words, the heater circuit 14 may be configured not to include the jumpers 14c as shown in FIG. 12 or may be configured to include the jumpers 14c as shown in FIGS. 8, 10, and 11. Similarly to the heater circuit 14, the inside zone heater circuit 14a and the outside zone heater circuit 14b both include the heater coil part 16 and the heater element wire part 18. The inside zone heater circuit 14a is embedded in the inside zone Z1 of the ceramic plate 12; however, as shown in FIG. 12, the inside zone heater circuit 14a may expand not only in the inside zone Z1 but also in the outside zone Z2. In that situation, it is suggested that the inside zone heater circuit 14a be configured to heat the inside zone Z1 selectively or with priority. The outside zone heater circuit 14b is embedded in the outside zone Z2 of the ceramic plate 12; however, as shown in FIG. 12, the outside zone heater circuit 14b may expand not only in the outside zone Z2 but also in the inside zone Z1. In that situation, it is suggested that the outside zone heater circuit 14b be configured to heat the outside zone Z2 selectively or with priority. Accordingly, as shown in FIG. 12, the inside zone heater circuit 14a and the outside zone heater circuit 14b may overlap with each other in a planar perspective view of the ceramic plate 12. In any of these aspects, it is desirable that the inside zone heater circuit 14a and the outside zone heater circuit 14b are each arranged in the form of a single uninterrupted line in a planar perspective view. The form of the single uninterrupted line may be any of various publicly-known forms, such as a form in which advancing and folding back repeatedly alternate or a swirl.

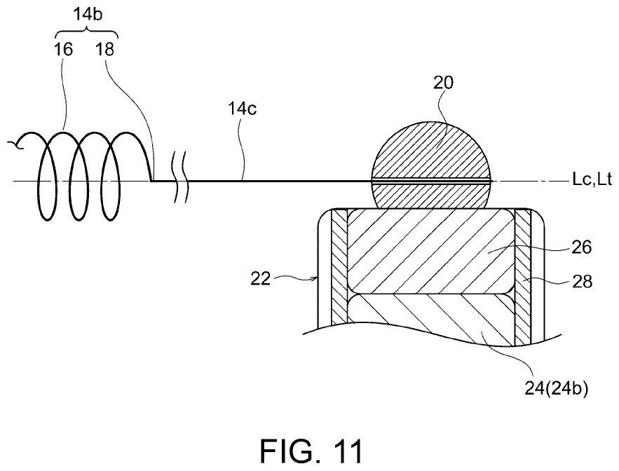

In an aspect in which the heater circuit 14 includes the jumpers 14c, the jumpers 14c are, as shown in FIGS. 8, 10, and 11, embedded in the inside zone Z1 of the ceramic plate 12 so as not to be in contact with the inside zone heater circuit 14a and are composed of resistive heating elements in an element wire form extending from the heater element wire part 18 of the outside zone heater circuit 14b. As shown in FIG. 8, the inside zone heater circuit 14a and the outside zone heater circuit 14b may be arranged on mutually the same plane in a cross-sectional view. Alternatively, the inside zone heater circuit 14a and the outside zone heater circuit 14b may be arranged on mutually-different planes in a cross-sectional view. As shown in FIGS. 3 and 11, the inside zone heater circuit 14a and the jumpers 14c are each connected to a pair of spherical terminals 20. To each of the pairs of spherical terminals 20, a heater rod 24 is connected. It should be noted, however, that the jumpers 14c do not need to be arranged at the same depth position as the lower end of the heater coil part 16 of the outside zone heater circuit 14b or at a deeper depth position closer to the second surface 12b. The reason is that it is possible, via the jumpers 14c, to sufficiently keep the heater coil part 16 of the outside zone heater circuit 14b away from the heater terminal holes 22 (in particular, the hole bottoms thereof) and that there is consequently a low risk of having the heater coil part 16 of the outside zone heater circuit 14b exposed in the heater terminal holes 22. Further, in FIG. 11, the jumper 14c and the terminal centerline Lt of the spherical terminal 20 are substantially aligned in the cross-sectional view; however, it is also acceptable to arrange the spherical terminal 20 in such a manner that the terminal centerline Lt is positioned closer to the second surface 12b, by slanting or partially curving the jumper 14c in a cross-sectional view. With this configuration, it is possible to keep the jumper 14c away from the hole bottom of the heater terminal hole 22.

In an aspect in which the heater circuit 14 does not include the jumpers 14c, the inside zone heater circuit 14a and the outside zone heater circuit 14b may each be connected to a pair of spherical terminals 20, and to each of the pairs of spherical terminals 20 a heater rod 24 may be connected, as shown in FIG. 12. In other words, to each of the two ends of the inside zone heater circuit 14a, a first heater rod 24a is connected. Meanwhile, to each of the two ends of the outside zone heater circuit 14b, a second heater rod 24b is connected. The heater rods 24 (i.e., the first heater rods 24a and the second heater rods 24b) are electrode terminals in a rod form. The inside zone heater circuit 14a and the outside zone heater circuit 14b are connected to a heater power source (not shown) via the first heater rods 24a and the second heater rods 24b, respectively. In this aspect, it is desirable to arrange the inside zone heater circuit 14a and the outside zone heater circuit 14b on mutually-different planes, in a cross-sectional view of the ceramic plate 12, as shown in FIG. 12. In that situation, because the heater coil part 16 is easily kept away from the hole bottom of the heater terminal hole 22 in each zone, it is possible to prevent the exposure of the heater coil part 16 and to arrange a larger part of the heater coil part 16. As a result, it is possible to solve the problem of the cool spot more effectively.

The inside zone heater circuit 14a may be embedded at least in the inside zone Z1 of the ceramic plate 12, while being positioned substantially parallel to the first surface 12a. The inside zone heater circuit 14a includes the heater coil part 16 and the heater element wire part 18. The inside zone Z1 of the ceramic plate 12 may be provided with the pair of first heater rods 24a for feeding electric power to the inside zone heater circuit 14a. Preferably, the first heater rod 24a may be connected to each of the two ends of the inside zone heater circuit 14a. There may be two or more pairs of first heater rods 24a. The first heater rods 24a may be identical to the heater rods 24 used in a one-zone heater. The inside zone heater circuit 14a is connected to the heater power source (not shown) via the first heater rods 24a.

The outside zone heater circuit 14b may be embedded at least in the outside zone Z2 of the ceramic plate 12, while being positioned substantially parallel to the first surface 12a at a depth position that is the same as or different from that of the inside zone heater circuit 14a. In a preferred aspect of the present invention, as shown in FIG. 8, the outside zone heater circuit 14b may be embedded in the outside zone Z2 of the ceramic plate 12, while being positioned substantially parallel to the first surface 12a at the same depth position as that of the inside zone heater circuit 14a. In that situation, it is desirable to arrange the coil centerline Lc of the heater coil part 16 of the inside zone heater circuit 14a and the coil centerline Lc of the heater coil part 16 of the outside zone heater circuit 14b, as well as the jumpers 14c if present, on substantially the same plane as one another. In another preferred aspect of the present invention, as shown in FIG. 12, the outside zone heater circuit 14b may be embedded in the outside zone Z2 of the ceramic plate 12, while being positioned substantially parallel to the first surface 12a at a different depth position from that of the inside zone heater circuit 14a. In FIG. 12, the outside zone heater circuit 14b is embedded to be higher than the inside zone heater circuit 14a (i.e., at a depth position closer to the first surface 12a); however, possible configurations are not limited to this example. Thus, the outside zone heater circuit 14b may be embedded to be lower than the inside zone heater circuit 14a (i.e., at a depth position closer to the second surface 12b).

In an aspect in which the heater circuit 14 includes the jumpers 14c, the inside zone Z1 of the ceramic plate 12 (in particular, in different positions from the first heater rods 24a within an inside region of the ceramic shaft 38 in a planar view) may be provided with the pair of second heater rods 24b for feeding electric power to the outside zone heater circuit 14b via the jumpers 14c. In other words, because the pair of second heater rods 24b are positioned distant from the outside zone heater circuit 14b, the pair of second heater rods 24b are electrically connected to the outside zone heater circuit 14b via the pair of jumpers 14c. There may be two or more pairs of second heater rods 24b. The second heater rod 24b are electrode terminals in a rod form. The outside zone heater circuit 14b is connected to the heater power source (not shown) via the jumpers 14c and the second heater rods 24b.

The outside zone heater circuit 14b may be a serial circuit or a parallel circuit. In other words, when forming a serial circuit, the outside zone heater circuit 14b may be provided so as to start from one of the pair of jumpers 14c in one direction and to reach the other of the pair of jumpers 14c in the manner of a single uninterrupted line. Alternatively, when forming a parallel circuit, the outside zone heater circuit 14b may be provided so as to start from one of the pair of jumpers 14c in two directions and to reach the other of the pair of jumpers 14c in the manner of a single uninterrupted line with respect to each starting direction.

The pair of jumpers 14c are embedded in the inside zone Z1 of the ceramic plate 12 so as not to be in contact with the inside zone heater circuit 14a and are electrically connected to the outside zone heater circuit 14b. The pair of jumpers 14c may be embedded, while being positioned substantially parallel to the first surface 12a, at a depth position that is the same as or different from that of the outside zone heater circuit 14b. The pair of jumpers 14c are separate from each other. One of the jumpers 14c electrically connects one of the second heater rods 24b to one end of the outside zone heater circuit 14b, whereas the other jumper 14c electrically connects the other of the second heater rods 24b to the other end of the outside zone heater circuit 14b. There may be two or more pairs of jumpers 14c.

The jumpers 14c are composed of the resistive heating elements in an element wire form. Although the specific form of the element wires is not particularly limited, typical examples include a straight line, a curved line (e.g., an arc), and a combination of a straight line and a curved line (e.g., a straight line that is partially bent with a curvature).

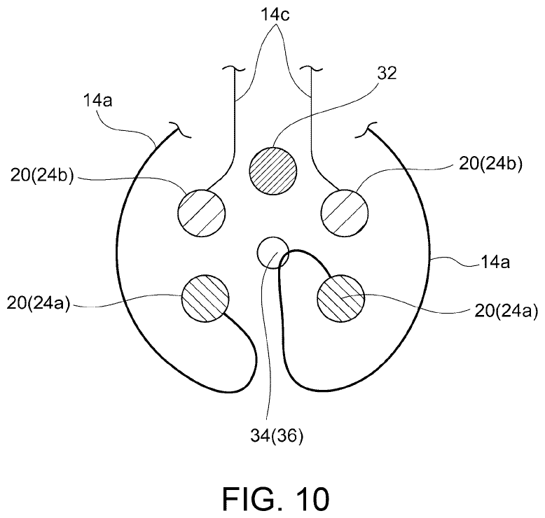

In a planar view of the ceramic plate 12, it is desirable that the pair of jumpers 14c and the pair of second heater rods 24b are arranged, as shown in FIG. 10, so as to be symmetrical with respect to the perpendicular bisector of a line segment connecting the pair of second heater rods 24b together. With this configuration, it is possible to make equal the lengths of power feeding paths from the pair of second heater rods 24b to the outside zone heater circuit 14b via the pair of jumpers 14c and to thus realize excellent temperature uniformity even more easily.

The buffering members 26 may be provided at the hole bottoms of the heater terminal holes 22. The buffering members 26 are metal members provided as buffers for mitigating a thermal expansion difference between the spherical terminals 20 and the heater rods 24 and are each provided between a spherical terminal 20 and a heater rod 24. Preferable examples of the metal of which the buffering members 26 are composed include an alloy such as Kovar® (an Fe—Ni—Co alloy).

The eyelets 28 are cylindrical members made of metal that are housed in or fitted with the heater terminal holes 22. The eyelets 28 have a function of guiding the heater rods 24 so as to be smoothly inserted into the heater terminal holes 22. The eyelets 28 may each have a screw thread formed thereon. In that situation, providing also the heater rods 24 each with a screw thread makes it possible to have the heater rods 24 inserted while being threadedly engaged with the eyelets 28. The metal of which the eyelets 28 are composed is not particularly limited, but desirable examples thereof include Ni, W, Mo, and a W—Mo alloy, and may preferably be Ni. Further, the eyelets 28 may each have a male screw thread formed on an outer circumference thereof. Providing a threaded part makes it possible to have the heater rods 24 threadedly engaged with the eyelets 28.

When the buffering members 26 and/or the eyelets 28 are used, it is desirable to wax-bond the spherical terminals 20, the heater rods 24, and the buffering members 26 and/or the eyelets 28 with one another.

The ceramic plate 12 may further include the RF electrode 30 and/or an ESC electrode. In that situation, it is desirable to have the RF electrode 30 and/or the ESC electrode embedded in the ceramic plate 12 at a depth position closer to the first surface 12a relative to the heater circuit 14. When a radio frequency is applied thereto, the RF electrode 30 makes it possible to perform film formation using a plasma CVD process. The ESC electrode is an abbreviation for an Electrostatic Chuck (ESC) electrode and may be referred to as an electrostatic electrode. The ESC electrode is configured, when voltage is applied thereto from an external power source, to chuck a wafer placed on a surface of the ceramic plate 12 with Johnson-Rahbek force. The ESC electrode may preferably be a circular thin-layer electrode which has a diameter slightly smaller than that of the ceramic plate 12 and may be, for example, a mesh-like electrode obtained by weaving a fine metal wire into a sheet form like a net. The ESC electrode may also be used as a plasma electrode. In other words, by applying a radio frequency to the ESC electrode, it is also possible to use the ESC electrode as an RF electrode and to thus perform film formation using a plasma CVD process. To the RF electrode 30 or the ESC electrode, an RF rod 32 or an ESC rod for feeding electric power is connected. The RF rod 32 or the ESC rod is an electrode terminal in a rod form. The RF electrode 30 or the ESC electrode is connected to an external power source (not shown) via the RF rod 32 or the ESC rod.

A temperature measurement hole 34 may be provided in the second surface 12b of the ceramic plate 12. The temperature measurement hole 34 may be a thermocouple hole for a temperature measuring purpose that is generally used in ceramic heaters. Accordingly, by inserting a thermocouple 36 or a temperature measurement resistance body in the temperature measurement hole 34, it is possible to measure temperatures of the ceramic plate 12. The temperature measurement hole 34 may be a vertical hole, a horizontal hole, or a combination of the two and may be formed to fit a region where the temperatures are to be measured.

The ceramic shaft 38 may optionally be attached to the second surface 12b of the ceramic plate 12. The ceramic shaft 38 is a circular cylindrical member including an internal space S and may have a configuration similar to or the same as that of a ceramic shaft adopted in a publicly-known ceramic susceptor or ceramic heater. The internal space S is configured so that the heater rods 24, the RF rod 32, the thermocouple 36, and the like pass therethrough. It is desirable that the ceramic shaft 38 is composed of a ceramic material that is the same as or similar to that of the ceramic plate 12. Accordingly, the ceramic shaft 38 may preferably contain aluminum nitride or aluminum oxide, and more preferably, may contain aluminum nitride. It is desirable that the upper end face of the ceramic shaft 38 is bonded to the second surface 12b of the ceramic plate 12 by solid phase bonding or diffusion bonding. Although not particularly limited, it is desirable that the outside diameter of the ceramic shaft 38 is in the range of 40 mm to 60 mm. Although not particularly limited either, it is desirable that the inside diameter of the ceramic shaft 38 (the diameter of the internal space S) is in the range of 33 mm to 55 mm.

### EXAMPLES

The present invention will be described more specifically by using the following examples; however, the present invention is not limited to the following examples.

### Example 1

### (1) Producing a Ceramic Heater

By using the following constituent members, a ceramic heater 10 was produced according to a publicly-known procedure except for firing conditions thereof, the ceramic heater 10 having the one-zone heater structure shown in FIGS. 1 and 2 and the terminal connection structure shown in FIG. 3, while satisfying the conditions presented in Tables 1 and 2.

### <the Constituent Members and Specifications Thereof>

The ceramic plate 12: A disc-shaped sintered body of aluminum nitride (diameter: 330 mm; thickness: 20 mm) (in which the heater circuit 14, the spherical terminals 20, and the RF electrode 30 were embedded inside);
The heater circuit 14: A circuit which was embedded at a depth of 10 mm from the first surface 12a according to a prescribed circuit pattern and was composed of: the heater coil part 16 (material: molybdenum; winding diameter: 3.5 mm; wire diameter 0.5 mm) composed of a resistive heating element in a three-dimensional coil form; and the heater element wire part 18 composed of a resistive heating element (material: molybdenum; wire diameter: 0.5 mm) in an element wire form not wound in a coil form;
The spherical terminals 20: spherical members (diameter: 4.0 mm) made of molybdenum in which a through hole for inserting and connecting the heater element wire part 18 was formed along the terminal centerline Lt;
An RF terminal hole: a bottomed hole having a nominal diameter of 7 mm (M7);
The heater terminal holes 22: bottomed holes having a nominal diameter of 7 mm (M7);
The heater rods 24: two terminal rods made of nickel
The buffering members 26: metal component parts made of Kovar® (an Fe—Ni—Co alloy);
The eyelets 28: circular cylindrical members made of nickel;
The RF electrode 30: A disc-shaped molybdenum electrode having a diameter of 320 mm and being embedded at a depth of 1.0 mm from the first surface 12a of the ceramic plate 12;
The RF rod 32: a terminal rod made of nickel; and
The ceramic shaft 38: A circular cylindrical sintered body of aluminum nitride (height: 172 mm; outside diameter: 42 mm; inside diameter: 36 mm).

The ceramic plate 12 in which the heater circuit 14, the spherical terminals 20, and the RF electrode 30 were embedded inside was produced with the following procedure. To begin with, aluminum nitride powder was press-molded to obtain a first aluminum nitride powder compact. By arranging aluminum nitride powder, the heater circuit 14, and the spherical terminals 20 according to a prescribed circuit pattern on the obtained first aluminum nitride powder compact and press-molding, a second aluminum nitride powder compact was obtained in which the heater circuit 14 and the spherical terminals 20 were embedded inside. In this situation, the arrangement of the heater circuit 14 and the spherical terminals 20 was realized by inserting and connecting end parts of the heater element wire part 18 into the through holes of the spherical terminals 20 to produce a wiring assembly, in advance, composed of the heater circuit 14 and the spherical terminals 20 and further arranging the wiring assembly on the first aluminum nitride powder compact. By arranging aluminum nitride powder and the RF electrode 30 on the obtained second aluminum nitride powder compact and press-molding, a third aluminum nitride powder compact was obtained in which the RF electrode 30 was further embedded inside. As a result, as shown in FIG. 1, a press-molded body composed of an aluminum nitride powder compact was obtained in which the heater circuit 14, the spherical terminals 20, and the RF electrode 30 were embedded. The obtained press-molded body (a stacked body) was fired under the following firing conditions in an atmosphere of nitrogen, to obtain the ceramic plate 12 in which the heater circuit 14, the spherical terminals 20, and the RF electrode 30 were embedded inside:
The maximum temperature: 1810° C.;
The time period held at the maximum temperature: 5 hours;
The temperature increasing rate: Varied within the range of 10° C./minute to 120° C./minute (which was a temperature range that included the temperature increasing rate at each of a plurality of temperature increasing stages); and
The firing pressure: 90 kg/cm².

### (2) Evaluations

Various evaluations were made on the obtained ceramic heater.

<a Maximum in-Plane Temperature Difference>

The ceramic heater 10 was installed in a chamber of a film formation device. The chamber was evacuated and N₂ gas was introduced therein so that the N₂ gas pressure in the chamber was 5 torr. By feeding electric power to the heater circuit 14 via the heater rods 24, the ceramic heater 10 was heated to a setting temperature of 550° C. At that setting temperature, a temperature distribution was measured on the first surface 12a of the ceramic plate 12, by using an infrared camera. On the basis of an obtained temperature distribution map, the difference between a maximum temperature and a minimum temperature (i.e., a maximum in-plane temperature difference) was calculated as an index for temperature uniformity. The result is presented in Table 2.

### <Cool Spot>

On the basis of the temperature distribution map obtained as described above, it was checked to see whether or not a cool spot where the temperature locally dropped was present in a central region having a radius of 30 mm (i.e., a diameter of 60 mm) from the center of the ceramic plate 12. As a result, no cool spot was observed in the present example, as presented in Table 2.

### <Occurrence of Cracks During an Operation>

The ceramic heater 10 was installed in a chamber of a film formation device. The chamber was evacuated and N₂ gas was introduced therein so that the N₂ gas pressure in the chamber was 5 torr. By feeding electric power to the heater circuit 14 via the heater rods 24, the ceramic heater 10 was heated from room temperature (20° C.) to a setting temperature of 550° C. at a temperature increasing rate of 20° C./min. After the temperature was maintained at 550° C. for 10 minutes, the electric power supply was stopped to let the temperature drop to room temperature (20° C.). The cycle of increasing the temperature from 20° C. to 550° C. and letting the temperature drop to 20° C. was repeated 100 times in total. After that, it was checked to see whether or not cracks occurred in the ceramic plate 12 by using an ultrasound flaw detection device. As presented in Table 2, it was confirmed that no cracks occurred in the present example.

### <Coil Exposure During the Production>

In the ceramic plate 12 in which the heater circuit 14, the spherical terminals 20, and the RF electrode 30 were embedded inside, the heater terminal holes 22 were formed by a grinding process so as to extend from the second surface 12b to reach a part of the spherical terminals 20. At that time, it was checked to see whether or not an event occurred where the heater coil part 16 was exposed in any of the heater terminal holes 22. As a result, in the present example, as shown in Table 2, there was no event in which the heater coil part 16 was exposed in the heater terminal holes 22.

### Example 2

As shown in FIG. 7, the ceramic heater 10 was produced as in Example 1, except that the ceramic shaft 38 was eliminated from the structure, while satisfying the conditions presented in Tables 1 and 2. Thus, the ceramic heater 10 in the present example had a structure corresponding to FIGS. 2, 3, and 7. The results are presented in Table 2.

### Example 3

### (1) Producing a Ceramic Heater

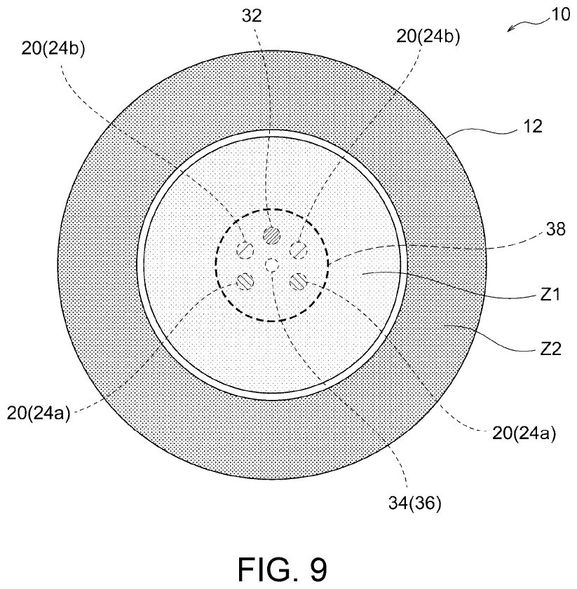

By using the following constituent members, a ceramic heater 10 was produced according to a method that was changed as appropriate following Example 1, the ceramic heater 10 having the planar two-zone heater structure shown in FIGS. 8 and 9 and the terminal connection structure shown in FIGS. 3, 10, and 11, while satisfying the conditions presented in Tables 1 and 2.

### <the Constituent Members and Specifications Thereof>

The ceramic plate 12: A disc-shaped sintered body of aluminum nitride (diameter: 330 mm; thickness: 20 mm) (in which the inside zone heater circuit 14a, the outside zone heater circuit 14b, the jumpers 14c, the spherical terminals 20, and the RF electrode 30 were embedded inside);
The inside zone Z1: a circular region having a diameter of 216 mm positioned at the center of the ceramic plate 12;
The outside zone Z2: an annular region outside the inside zone Z1 of the ceramic plate 12;
The inside zone heater circuit 14a: A circuit which was embedded at a depth of 6.5 mm from the first surface 12a in the inside zone Z1 according to a prescribed pattern and was composed of: the heater coil part 16 (material: molybdenum; winding diameter: 3.5 mm; wire diameter 0.5 mm) composed of a resistive heating element in a three-dimensional coil form; and the heater element wire part 18 composed of a resistive heating element (material: molybdenum; wire diameter: 0.5 mm) in an element wire form not wound in a coil form;
The outside zone heater circuit 14b: A circuit which was embedded at a depth of 6.5 mm from the first surface 12a in the outside zone Z2 according to a prescribed pattern and was composed of: the heater coil part 16 (material: molybdenum; winding diameter: 3.5 mm; wire diameter 0.5 mm) composed of a resistive heating element in a three-dimensional coil form; and the heater element wire part 18 composed of a resistive heating element (material: molybdenum; wire diameter: 0.5 mm) in an element wire form not wound in a coil form;
The jumpers 14c: A pair of substantially linear resistance heat generation wires (material: molybdenum; wire diameter: 0.5 mm) which were bilaterally symmetrical and were embedded at a depth of 6.5 mm from the first surface 12a in the inside zone Z1, so as to be embedded according to the circuit pattern shown in FIG. 10;
The spherical terminals 20: spherical members (diameter: 4.0 mm) made of molybdenum in which through holes for inserting and connecting the heater element wire part 18 were formed along the terminal centerline Lt;
An RF terminal hole: a bottomed hole having a nominal diameter of 7 mm (M7);
The heater terminal holes 22: bottomed holes having a nominal diameter of 7 mm (M7);
The first heater rods 24a: two terminal rods made of nickel.

The second heater rods 24b: two terminal rods made of nickel
The buffering members 26: metal component parts made of Kovar® (an Fe—Ni—Co alloy);
The eyelets 28: circular cylindrical members made of nickel;
The RF electrode 30: A disc-shaped molybdenum electrode having a diameter of 320 mm and being embedded at a depth of 1.0 mm from the first surface 12a of the ceramic plate 12;
The RF rod 32: a terminal rod made of nickel; and
The ceramic shaft 38: A circular cylindrical sintered body of aluminum nitride (height: 172 mm; outside diameter 42 mm; inside diameter 36 mm).

### (2) Evaluations

Various evaluations were made on the obtained ceramic heater, as in Example 1. The results are presented in Table 2.

### Example 4

### (1) Producing a Ceramic Heater

By using the following constituent members, a ceramic heater 10 was produced according to a method that was changed as appropriate following Example 1, the ceramic heater 10 having the stacked-type two-zone heater structure shown in FIGS. 9 and 12 and the terminal connection structure shown in FIG. 13, while satisfying the conditions presented in Tables 1 and 2.

### <the Constituent Members and Specifications Thereof>

The ceramic plate 12: A disc-shaped sintered body of aluminum nitride (diameter: 330 mm; thickness: 20 mm) (in which the inside zone heater circuit 14a, the outside zone heater circuit 14b, the jumpers 14c, the spherical terminals 20, and the RF electrode 30 were embedded inside);
The inside zone Z1: a circular region having a diameter of 216 mm positioned at the center of the ceramic plate 12;
The outside zone Z2: an annular region outside the inside zone Z1 of the ceramic plate 12;
The inside zone heater circuit 14a: A circuit which was embedded at a depth of 11.5 mm from the first surface 12a in the inside zone Z1 and the outside zone Z2 (the region having a diameter of 320 mm) of the ceramic plate 12 according to a prescribed pattern and was composed of: the heater coil part 16 (material: molybdenum; winding diameter: 3.5 mm; wire diameter 0.5 mm) composed of a resistive heating element in a three-dimensional coil form; and the heater element wire part 18 composed of a resistive heating element (material: molybdenum; wire diameter: 0.5 mm) in an element wire form not wound in a coil form (It should be noted that the heater coil part 16 was configured so that the coil pitch thereof became smaller (the coil became denser) as the distance to the center of the ceramic plate 12 decreased, to make it possible to heat the inside zone Z1 selectively or with priority);
The outside zone heater circuit 14b: A circuit which was embedded at a depth of 6.5 mm from the first surface 12a in the inside zone Z1 and the outside zone Z2 (the region having a diameter of 320 mm) of the ceramic plate 12 according to a prescribed pattern and was composed of: the heater coil part 16 (material: molybdenum; winding diameter: 3.5 mm; wire diameter 0.5 mm) composed of a resistive heating element in a three-dimensional coil form; and the heater element wire part 18 composed of a resistive heating element (material: molybdenum; wire diameter: 0.5 mm) in an element wire form not wound in a coil form (It should be noted that the heater coil part 16 was configured so that the coil pitch thereof became smaller (the coil became denser) as the distance to the outer circumference of the ceramic plate 12 decreased, to make it possible to heat the outside zone Z2 selectively or with priority);
The spherical terminals 20: spherical members (diameter: 4.5 mm) made of molybdenum in which through holes for inserting and connecting the heater element wire part 18 were formed along the terminal centerline Lt;
An RF terminal hole: a bottomed hole having a nominal diameter of 7 mm (M7);
The heater terminal holes 22: bottomed holes having a nominal diameter of 7 mm (M7);
The first heater rods 24a: two terminal rods made of nickel.

The second heater rods 24b: two terminal rods made of nickel
The buffering members 26: metal component parts made of Kovar® (an Fe—Ni—Co alloy);
The eyelets 28: circular cylindrical members made of nickel;
The RF electrode 30: A disc-shaped molybdenum electrode having a diameter of 320 mm and being embedded at a depth of 1.0 mm from the first surface 12a of the ceramic plate 12;
The RF rod 32: a terminal rod made of nickel; and
The ceramic shaft 38: A circular cylindrical sintered body of aluminum nitride (height: 172 mm; outside diameter 42 mm; inside diameter 36 mm).

The ceramic plate 12 described above in which the inside zone heater circuit 14a, the outside zone heater circuit 14b, the spherical terminals 20, and the RF electrode 30 were embedded inside was produced with the following procedure. To begin with, aluminum nitride powder was press-molded to obtain a first aluminum nitride powder compact. By arranging aluminum nitride powder, the inside zone heater circuit 14a, and the spherical terminals 20 according to a prescribed circuit pattern on the obtained first aluminum nitride powder compact and press-molding, a second aluminum nitride powder compact was obtained in which the inside zone heater circuit 14a and the spherical terminals 20 were embedded inside. In this situation, the arrangement of the inside zone heater circuit 14a and the spherical terminals 20 was realized by inserting and connecting end parts of the heater element wire part 18 into the through holes of the spherical terminals 20 to produce a wiring assembly, in advance, composed of the inside zone heater circuit 14a and the spherical terminals 20 and further arranging the wiring assembly on the first aluminum nitride powder compact. By arranging aluminum nitride powder, the outside zone heater circuit 14b, and the spherical terminals 20 on the obtained second aluminum nitride powder compact and press-molding, a third aluminum nitride powder compact was obtained in which the outside zone heater circuit 14b was further embedded inside. In this situation, the arrangement of the outside zone heater circuit 14b and the spherical terminals 20 was realized by inserting and connecting end parts of the heater element wire part 18 into the through holes of the spherical terminals 20 to produce a wiring assembly, in advance, composed of the outside zone heater circuit 14b and the spherical terminals 20 and further arranging the wiring assembly on the second aluminum nitride powder compact. By arranging aluminum nitride powder and the RF electrode 30 on the obtained third aluminum nitride powder compact and press-molding, a fourth aluminum nitride powder compact was obtained in which the RF electrode 30 was further embedded inside. As a result, as shown in FIG. 12, a press-molded body composed of an aluminum nitride powder compact was obtained in which the inside zone heater circuit 14a, the outside zone heater circuit 14b, the spherical terminals 20, and the RF electrode 30 were embedded. The obtained press-molded body (a stacked body) was fired under the following firing conditions in an atmosphere of nitrogen, to obtain the ceramic plate 12 in which the heater circuit 14, the spherical terminals 20, and the RF electrode 30 were embedded inside:
The maximum temperature: 1810° C.;
The time period held at the maximum temperature: 5 hours.
The temperature increasing rate: Varied within the range of 10° C./minute to 120° C./minute (which was a temperature range that included the temperature increasing rate at each of a plurality of temperature increasing stages); and
The firing pressure: 100 kg/cm².

### (2) Evaluations

Various evaluations were made on the obtained ceramic heater, as in Example 1. The results are presented in Table 2.

### Example 5 (Comparison)

A ceramic heater 10 was produced as in Example 1, except that the depth position of the heater element wire part 18 was changed so as to be aligned with the centerline Lc of the heater coil part 16 as shown in FIG. 14 and so as to satisfy the conditions presented in Tables 1 and 2. Accordingly, the ceramic heater 10 in the present example had the structure corresponding to FIGS. 1, 2, and 14. As presented in Table 2, the results indicated that the temperature uniformity was unsatisfactory and that a cool spot and cracks caused thereby occurred.

### Example 6 (Comparison)

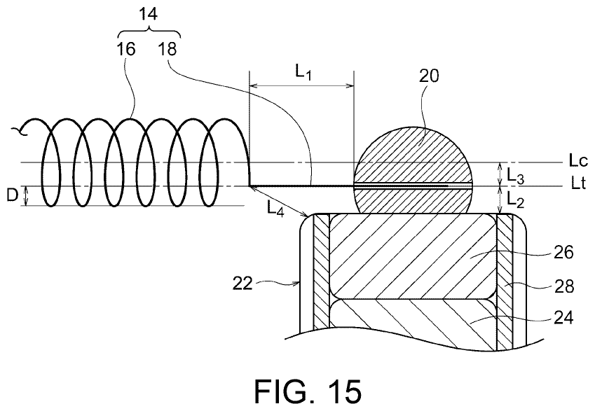

A ceramic heater 10 was produced as in Example 1, except that the depth position of the heater element wire part 18 was changed so as to be higher than the lower end of the heater coil part 16 and to be lower than the centerline Lc of the heater coil part 16 as shown in FIG. 15 and so as to satisfy the conditions presented in Tables 1 and 2. Accordingly, the ceramic heater 10 in the present example had the structure corresponding to FIGS. 1, 2, and 15. As presented in Table 2, the results indicated that the temperature uniformity was unsatisfactory, that a cool spot occurred, and that an event occurred where the heater coil part 16 was exposed in a heater terminal hole 22 during the production.

TABLE 1

| | Length L₁ (mm) of | Shortest distance L2 | Distance L₃ (mm) | Shortest distance L₄ | Distance L₅ (mm) in the |
|---|---|---|---|---|---|
| | the heater element | (mm) between the hole | between the centerline | (mm) between | thickness direction between |
| | wire part 18 on the | bottom of the heater | Lc of the heater coil part | the hole bottom of the | the hole bottom of the |
| | outside of the | terminal hole 22 and | 16 and the centerline Lt | heater terminal hole | heater terminal hole 22 and |
| | spherical terminal | the heater element wire | of the spherical terminal | 22 and the heater coil | the lower end of the heater |
| | 20 | part 18 | 20 | part 16 | coil part 16. |
| Ex. 1 | 2.1 | 1.5 | 2.3 | 1.7 | |
| Ex. 2 | 2.0 | 1.2 | 2.1 | 1.5 | |
| Ex. 3 | 2.2^{#} | 1.0^{#} | 1.8^{#} | 1.6^{#} | |
| Ex. 4 | 2.5 | | 2.8 | 3.5 | 3.0 |
| Ex. 5* | 4.5 | 1.2 | 0 | 3.0 | |
| Ex. 6* | 4.0 | 0.7 | | 2.5 | |

*Comparison Examples
^{#}Values of the inside zone heater circuit 14a (The outside zone heater is not applicable to the above, because the jumper 14c and the spherical terminal 20 are connected.)
Note:
The shortest distance L₄ denotes the length of the straight line having the shortest distance connecting a vertex or an inflection point formed by the heater coil part 16 and the heater element wire part 18 to the hole bottom of the heater terminal hole 22.

TABLE 2

| | | The Number | | | | | | |
|---|---|---|---|---|---|---|---|---|
| | | of Heater | | Depth Position D^{#} of the | Maximum | Cool Spot | | |
| | | Zones | | centerline Lt of the spherical | In-plane | in Central | | Coil |
| | | (and | | terminal 20 with respect to | Temperature | Region | Cracks | Exposure |
| | Corresponding | Arrangement | Ceramic | the lower end of the heater | Difference | (Diameter: | During | During |
| | Drawings | Type) | Shaft | coil part 16 | (° C.) | 60 mm) | Operation | Production |
| Ex. 1 | FIGS. 1 to 3 | 1 | Present | +0.5 mm from the coil lower end | 2.6 | Absent | Absent | Absent |
| Ex. 2 | FIG. 7 (and | 1 | Absent | +0.3 mm from the coil lower end | 2.9 | Absent | Absent | Absent |
| | FIGS. 2 and 3) | | | | | | | |
| Ex. 3 | FIGS. 8 to 11 | 2 (Flat | Present | ±0 mm from the coil lower end | 2.5 | Absent | Absent | Absent |
| | (and FIG. 3) | Type) | | | | | | |
| Ex. 4 | FIGS. 12 and 13 | 2 (Stacked | Present | +1.0 mm from the coil lower end | 2.7 | Absent | Absent | Absent |
| | (and FIG. 9) | Type) | | | | | | |
| Ex. 5* | FIG. 14 (and | 1 | Present | −1.2 mm from the coil lower end | 7.2 | Present | Present | Absent |
| | FIGS. 1 and 2) | | | | | | | |
| Ex. 6* | FIG. 15 (and | 1 | Present | −0.7 mm from the coil lower end | 6.3 | Present | Absent | Present |
| | FIGS. 1 and 2) | | | | | | | |

*Comparison Examples
^{#}Depth positions closer to the second surface 12b relative to the coil lower end are expressed with the positive sign (+), whereas depth positions closer to the first surface 12a relative to the coil lower end are expressed with the negative sign (−).

### REFERENCE SIGNS LIST

10: ceramic heater; 12: ceramic plate; 12a: first surface; 12b: second surface; 14: heater circuit; 14a: inside zone heater circuit; 14b: outside zone heater circuit; 14c: jumper; 16: heater coil part; 18: heater element wire part; 20: spherical terminal; 22: heater terminal hole; 24: heater rod; 24a: first heater rod; 24b: second heater rod; 26: buffering member; 28: eyelet; 30: RF electrode; 32: RF rod; 34: temperature measurement hole; 36: thermocouple; 38: ceramic shaft; W: wafer; D: depth position; C: virtual circle; Lt: terminal centerline; Lc: coil centerline; Z1: inside zone; Z2: outside zone; S: internal space.

What is claimed is:

1. A ceramic heater comprising:
a ceramic plate having a first surface for having a wafer placed thereon and a second surface opposite the first surface;
a heater circuit embedded in the ceramic plate;
at least one pair of spherical terminals that are embedded in the ceramic plate and are connected to the heater circuit;
at least one pair of heater terminal holes formed in the second surface of the ceramic plate so as to reach the spherical terminals, respectively; and
at least one pair of heater rods that are for feeding electric power to the heater circuit, are inserted in the heater terminal holes respectively, are also electrically connected to the spherical terminals respectively, and extend in a direction away from the first surface,
wherein the heater circuit includes
a heater coil part positioned parallel to the first surface and composed of a resistive heating element in a coil form, and
a heater element wire part composed of a resistive heating element in an element wire form not wound in a coil form, so as to extend from the heater coil part and so that a tip end thereof reaches an inside of the spherical terminals,
wherein, in a cross-sectional view of the ceramic plate, the heater element wire part is arranged at a same depth position as a lower end of the heater coil part or at a deeper depth position closer to the second surface, and
wherein a length L₁ of a part of the heater element wire part that is not embedded in the spherical terminal is in the range of 2.0 mm to 3.5 mm.

2. The ceramic heater according to claim 1, wherein, when a terminal centerline is defined as a line extending parallel to the first surface and passing through a center of a virtual circle specified by a cross-sectional arc of the spherical terminal in a cross-sectional view of the ceramic plate, the heater element wire part is arranged along the terminal centerline.

3. The ceramic heater according to claim 1, wherein the ceramic plate contains aluminum nitride or aluminum oxide.

4. The ceramic heater according to claim 1, wherein the spherical terminals are each composed of a resistive heating element having a same type of composition as that of the resistive heating element in the coil form.

5. The ceramic heater according to claim 1, wherein the resistive heating element contains at least one selected from the group consisting of tungsten, molybdenum, a tungsten-molybdenum alloy, tungsten carbide, a tungsten carbide titanium nitride composite material, a tungsten carbide aluminum oxide composite material, and niobium.

6. The ceramic heater according to claim 1, wherein, in a planar perspective view of the ceramic plate from the second surface, the heater coil part is not present in regions defined by the heater terminal holes.

7. The ceramic heater according to claim 1, further comprising a circular cylindrical ceramic shaft attached to the second surface of the ceramic plate and including an internal space.

8. The ceramic heater according to claim 1, wherein the heater element wire part does not penetrate the spherical terminals so as to protrude to an outside thereof, and the heater element wire part therefore terminates inside the spherical terminals.

9. The ceramic heater according to claim 1, wherein, in a planar view of the ceramic plate, the ceramic plate includes an inside zone defined as a circular region within a prescribed distance from a center of the ceramic plate; and an outside zone defined as an annular region outside the inside zone,
wherein the heater circuit includes:
an inside zone heater circuit embedded in the inside zone of the ceramic plate and including the heater coil part and the heater element wire part; and
an outside zone heater circuit embedded in the outside zone of the ceramic plate and including the heater coil part and the heater element wire part, and
wherein the pair of spherical terminals are connected to the inside zone heater circuit and to the outside zone heater circuit, respectively, and the heater rods are connected to the pair of spherical terminals, respectively.

10. The ceramic heater according to claim 9, wherein, in a cross-sectional view of the ceramic plate, the inside zone heater circuit and the outside zone heater circuit are arranged on mutually-different planes.

11. The ceramic heater according to claim 1, wherein, in a planar view of the ceramic plate, the ceramic plate includes an inside zone defined as a circular region within a prescribed distance from a center of the ceramic plate; and an outside zone defined as an annular region outside the inside zone,
wherein the heater circuit includes:
an inside zone heater circuit embedded in the inside zone of the ceramic plate and including the heater coil part and the heater element wire part;
an outside zone heater circuit embedded in the outside zone of the ceramic plate and including the heater coil part and the heater element wire part; and
a pair of jumpers that are embedded in the inside zone of the ceramic plate so as not to be in contact with the inside zone heater circuit and are composed of resistive heating elements in an element wire form extending from the heater element wire part of the outside zone heater circuit, and
wherein the pair of spherical terminals are connected to the inside zone heater circuit and to the jumpers, respectively, and the heater rods are connected to the pair of spherical terminals, respectively, with the proviso that the jumpers do not need to be arranged at the same depth position as the lower end of the heater coil part of the outside zone heater circuit or at a deeper depth position closer to the second surface.

12. The ceramic heater according to claim 11, wherein, in a cross-sectional view of the ceramic plate, the inside zone heater circuit and the outside zone heater circuit are arranged on a mutually same plane.

13. The ceramic heater according to claim 11, wherein, in a cross-sectional view of the ceramic plate, the inside zone heater circuit and the outside zone heater circuit are arranged on mutually-different planes.

14. A ceramic heater comprising:
a ceramic plate having a first surface for having a wafer placed thereon and a second surface opposite the first surface;
a heater circuit embedded in the ceramic plate;
at least one pair of spherical terminals that are embedded in the ceramic plate and are connected to the heater circuit;
at least one pair of heater terminal holes formed in the second surface of the ceramic plate so as to reach the spherical terminals, respectively; and
at least one pair of heater rods that are for feeding electric power to the heater circuit, are inserted in the heater terminal holes respectively, are also electrically connected to the spherical terminals respectively, and extend in a direction away from the first surface,
wherein the heater circuit includes
a heater coil part positioned parallel to the first surface and composed of a resistive heating element in a coil form, and
a heater element wire part composed of a resistive heating element in an element wire form not wound in a coil form, so as to extend from the heater coil part and so that a tip end thereof reaches an inside of the spherical terminals,
wherein, in a cross-sectional view of the ceramic plate, the heater element wire part is arranged at a same depth position as a lower end of the heater coil part or at a deeper depth position closer to the second surface, and
wherein a shortest distance La between a hole bottom of the heater terminal hole and the heater coil part is in the range of 1.5 mm to 4.0 mm, provided that the shortest distance L₄ is defined as a length of a shortest straight line that connects a vertex or an inflection point formed by the heater coil part and the heater element wire part to the hole bottom of the heater terminal hole, in a cross-sectional view of the ceramic plate.

15. The ceramic heater according to claim 14, wherein, when a terminal centerline is defined as a line extending parallel to the first surface and passing through a center of a virtual circle specified by a cross-sectional arc of the spherical terminal in a cross-sectional view of the ceramic plate, the heater element wire part is arranged along the terminal centerline.

16. The ceramic heater according to claim 14, wherein the ceramic plate contains aluminum nitride or aluminum oxide.

17. The ceramic heater according to claim 14, wherein the spherical terminals are each composed of a resistive heating element having a same type of composition as that of the resistive heating element in the coil form.

18. The ceramic heater according to claim 14, wherein the resistive heating element contains at least one selected from the group consisting of tungsten, molybdenum, a tungsten-molybdenum alloy, tungsten carbide, a tungsten carbide titanium nitride composite material, a tungsten carbide aluminum oxide composite material, and niobium.

19. The ceramic heater according to claim 14, wherein, in a planar perspective view of the ceramic plate from the second surface, the heater coil part is not present in regions defined by the heater terminal holes.

20. The ceramic heater according to claim 14, further comprising a circular cylindrical ceramic shaft attached to the second surface of the ceramic plate and including an internal space.

21. The ceramic heater according to claim 14, wherein the heater element wire part does not penetrate the spherical terminals so as to protrude to an outside thereof, and the heater element wire part therefore terminates inside the spherical terminals.

22. The ceramic heater according to claim 14, wherein, in a planar view of the ceramic plate, the ceramic plate includes an inside zone defined as a circular region within a prescribed distance from a center of the ceramic plate; and an outside zone defined as an annular region outside the inside zone,
wherein the heater circuit includes:
an inside zone heater circuit embedded in the inside zone of the ceramic plate and including the heater coil part and the heater element wire part; and
an outside zone heater circuit embedded in the outside zone of the ceramic plate and including the heater coil part and the heater element wire part, and
wherein the pair of spherical terminals are connected to the inside zone heater circuit and to the outside zone heater circuit, respectively, and the heater rods are connected to the pair of spherical terminals, respectively.

23. The ceramic heater according to claim 22, wherein, in a cross-sectional view of the ceramic plate, the inside zone heater circuit and the outside zone heater circuit are arranged on mutually-different planes.

24. The ceramic heater according to claim 14, wherein, in a planar view of the ceramic plate, the ceramic plate includes an inside zone defined as a circular region within a prescribed distance from a center of the ceramic plate; and an outside zone defined as an annular region outside the inside zone,
wherein the heater circuit includes:
an inside zone heater circuit embedded in the inside zone of the ceramic plate and including the heater coil part and the heater element wire part;
an outside zone heater circuit embedded in the outside zone of the ceramic plate and including the heater coil part and the heater element wire part; and
a pair of jumpers that are embedded in the inside zone of the ceramic plate so as not to be in contact with the inside zone heater circuit and are composed of resistive heating elements in an element wire form extending from the heater element wire part of the outside zone heater circuit, and
wherein the pair of spherical terminals are connected to the inside zone heater circuit and to the jumpers, respectively, and the heater rods are connected to the pair of spherical terminals, respectively, with the proviso that the jumpers do not need to be arranged at the same depth position as the lower end of the heater coil part of the outside zone heater circuit or at a deeper depth position closer to the second surface.

25. The ceramic heater according to claim 24, wherein, in a cross-sectional view of the ceramic plate, the inside zone heater circuit and the outside zone heater circuit are arranged on a mutually same plane.

26. The ceramic heater according to claim 24, wherein, in a cross-sectional view of the ceramic plate, the inside zone heater circuit and the outside zone heater circuit are arranged on mutually-different planes.
